(19) United States
(12) Patent Application Publication
(10) Pub. No.: US 2026/0043470 A1
(43) Pub. Date: Feb. 12, 2026

(54) METHOD FOR ENSURING A DESIRED SHIFTING STATE

(71) Applicant: ZF Friedrichshafen AG, Friedrichshafen (DE)

(72) Inventors: Hannes WERNER, Friedrichshafen (DE); Stefan BEMETZ, Wangen im Allgäu (DE); Alexey RYABININ, Markdorf (DE); Christian MITTELBERGER, Ravensburg (DE); Stefan BLATTNER, Ravensburg (DE); Xianghui SHEN, Singen (DE); Mario STEINBORN, Friedrichshafen (DE); Matthias MÜLLER, Wangen im Allgäu (DE); Benjamin BERGER, Markdorf (DE); Franz BITZER, Friedrichshafen (DE); Anton FRITZER, Markdorf (DE)

(73) Assignee: ZF Friedrichshafen AG, Friedrichshafen (DE)

(21) Appl. No.: 19/291,721

(22) Filed: Aug. 6, 2025

(30) Foreign Application Priority Data
Aug. 7, 2024 (DE) 10 2024 207 478.0

(51) Int. Cl. F16H 59/68; F16H 59/10; F16H 61/12

(52) U.S. Cl. CPC F16H 59/68; F16H 59/105; F16H 61/12; F16H 2059/6823

(57) ABSTRACT

A method for ensuring a desired shifting state in a shiftable electric drivetrain (16) of a vehicle (15) is characterized in that the method includes an ascertaining process during which it is ensured that the desired shifting state corresponds to an actual shifting state.

### RELATED APPLICATIONS

This application claims the benefit of and right of priority under 35 U.S. C. § 119 to German Patent Application no. 10 2024 207 478.0, filed on 7 Aug. 2024, the contents of which are incorporated herein by reference in its entirety.

### TECHNICAL FIELD

The invention relates to a method for ensuring a desired shifting state, and to a system, a vehicle, a computer program, and a computer-readable medium as disclosed herein.

### BACKGROUND

When vehicles that have been switched off are moved, attention typically must be paid to certain processes relating to the transmission of the vehicles. Particularly with vehicles that have shiftable electric drivetrains, depending on the application, it is possible to require either the mechanically neutral state of the electric drivetrain or that an engaged gear for moving the vehicle from a standstill is in the switched-off condition, for example. In this, it is problematic that precisely when towing such vehicles problems arise if the actually necessary shifting state is not in fact engaged.

### SUMMARY

The purpose of the present invention is to overcome or at least minimize the disadvantages of the prior art.

This objective is achieved by a method for ensuring that a desired shifting state has been produced in a shiftable electric drivetrain of a vehicle, such that the method includes an ascertaining process by virtue of which it is ensured that the desired shifting state corresponds to a shifting state actually engaged. In this context a shifting state, for example, is understood to mean a mechanically neutral condition or an engaged gear. “Ensuring” means, for example, that the vehicle is switched off or that it can only be switched on if it is ensured that the desired shifting state, i.e. for example a mechanically neutral condition, actually exists. By implementing such an ascertaining process, it can be ensured that a vehicle in which the method is implemented can be moved in its switched-off condition without problems, because the ascertaining process makes it possible to ensure that the desired shifting state corresponds to an actually existing shifting state.

In typical embodiments, the desired shifting state is a mechanically neutral condition or a condition in which a gear is engaged.

In advantageous embodiments, the method is suitable for offering a user the possibility of choosing whether the desired shifting stage should be the mechanically neutral condition or the condition with a gear engaged. In this context a “user” is understood in particular to be a person who configures the method or the vehicle in which the method is to take place for the first time. Such a choice possibility has the advantage that the method can be adapted to suit the vehicle concerned, i.e., in particular, in such manner as to ensure that when the vehicle is switched off, that either a gear is engaged or that the vehicle is in its mechanically neutral condition.

A reason for ensuring that a switched-off vehicle is in a mechanically neutral condition can be, for example, that for towing a truck some components have to be removed, such as cardan shafts. To make that possible it must be ensured that when the vehicle is switched off it is in the mechanically neutral condition. Further reasons for ensuring a mechanically neutral condition when switched off can relate to safety aspects, for example, a kind of immobilizer can be implemented in that way.

A reason for ensuring that a gear is engaged when the vehicle is switched off can be the following: when the vehicle moves the engaged gear ensures the activation of power-inverters in the vehicle, wherein the activation of the inverters results in the activation of a vehicle control unit which, for its part, activates an oil pump and in that way ensures the lubrication of the electric drivetrain. In vehicles of some designs this may be necessary when the vehicle is moved while switched off.

In advantageous embodiments, when the vehicle is switched off, then as part of the ascertaining process the following steps are carried out: a switching-off test step in which it is checked whether the desired shifting state corresponds to the actual shifting state; a switching-off shifting step in which preferably automatic shifting of the electric drivetrain to the desired shifting state takes place, in particular if during the switching-off test step it was determined that the desired shifting state does not correspond to the actual shifting state; and a system switching-off step in which the vehicle is switched off completely as soon as the desired shifting state corresponds to the actual shifting state. In this case the switching-off shifting step is typically only carried out when in the switching-off test step it was determined that the desired shifting state does not correspond to the actual shifting state. In this context, “switching off” is understood in particular to mean that a driver of the vehicle carried out an initial switching-off step, for example turning the ignition key in order to switch off, whereby for example terminal 15 is switched off. Complete switching off of the vehicle is typically understood to mean that a connection between a battery of the vehicle and all the electrical consumers of the vehicle is completely broken, for example by deactivating terminal 30. The switching-off test step does not unconditionally have to be available. Rather, in advantageous embodiments, even after the initial switching-off step described and/or after the deactivation of terminal 15 a direct shift to the desired shifting state can be forced. In such a case it is then also possible for the existing switching-off test step to be carried out after the switching-off shifting step.

In advantageous embodiments, when the vehicle is switched off, then as part of the ascertaining process the following steps are carried out: a switching-on test step in which it is determined whether the desired shifting state corresponds to the actual shifting state; a switching-on shifting step is which a preferably automatic shift of the electric drivetrain to the desired shifting state takes place, particularly if during the switching-on test step it was determined that the desired shifting state corresponds to the actual shifting state; and a complete switching-on step in which the vehicle is switched on fully as soon as the desired shifting state corresponds to the actual shifting state. Thus, in typical embodiments the switching-on step is only carried out if during the switching-on test step it was determined that the desired shifting state does correspond to the actual shifting state. In this context, “switching on” is typically understood to mean that a driver has carried out an initial switching-on step, for example by turning an ignition key to a first position so that in a first step terminal 30 is activated and/or a connection is established between a vehicle battery and electrical consumers of the vehicle. In such a case, terminal 15 is typically still deactivated. Complete switching-on of the vehicle is then understood to mean that terminal 15 is also activated so that the vehicle is then typically in a condition in which full operation of the vehicle is possible, in principle. The switching-on test step does not unconditionally have to be available. Rather, in typical embodiments, it is also possible that after an initial switching-on step, i.e., in particular after an activation of terminal 30, a shift into the desired shifting state is forced. In such a case it is then also possible that the then optional switching-on test step can take place after the switching-on shifting step.

In advantageous embodiments, the method includes a shift-enabling process, which is typically carried out after the complete switching-on step has been carried out, wherein the shift-enabling process includes the following steps: a shift-enabling test step, in which it is tested whether a shift-lever actuation from a neutral position to a forward-driving shift position or to a reverse-driving shift position has taken place; and a shift-enabling step in which a shift of the electric drivetrain is fully permitted as soon as, in the shift-enabling test step, it has been recognized that the shift-lever actuation into the forward-driving or the reverse-driving shift position has taken place. Thus, in such an embodiment, so long as no shifting request from the neutral condition to the forward-driving or the reverse-driving shift position has been recognized, in such embodiments the shifting of the electric drivetrain is not completely enabled.

The objective is also achieved by a system comprising means for at least partially carrying out a method according to at least one of the above-mentioned embodiments.

Typically, such a system comprises at least one selection component which offers the user the possibility of choosing whether the desired shifting state should be the mechanically neutral condition or the condition with a gear engaged, and/or a switching-off component which in particular is suitable for carrying out the switching-off test step and/or the switching-off shifting step and/or the system switching-off step, and/or a switching-on component which in particular is suitable for carrying out the switching-on test step and/or the switching-on shifting step and/or the complete switching-on step. In typical embodiments the system comprises a shift-enabling component which is suitable for carrying out the shift-enabling process, at least in part.

In advantageous embodiments the system is suitable for carrying out, at least in part, a method for ensuring a desired shifting state in a shiftable electric drivetrain of a vehicle in accordance with at least one of the above-mentioned embodiments, and/or for coordinating and/or controlling it. For that purpose, the system typically comprises means for carrying out and/or coordinating and/or controlling a method in accordance with at least one of the above-mentioned embodiments.

Advantageously, in the system at least some of the above-mentioned components are implemented by means of computer program codes. In advantageous embodiments, the system, in particular at least some of the aforesaid components, are at least partially part of a vehicle control unit and/or stored in the Cloud. In typical embodiments, the system is a control unit, in particular a vehicle control unit.

In an embodiment of the invention, a vehicle is suitable for carrying out a method in accordance with at least one of the aforesaid embodiments and/or comprises a system according to one of the aforesaid embodiments. For that purpose, the vehicle typically contains means for carrying out a method in accordance with at least one of the aforesaid embodiments.

In an embodiment of the invention, a computer program comprises commands which, when the computer program is run on a computer, enable it to carry out one of the above methods. The computer program can also be called a computer program product.

In an embodiment of the invention, a computer-readable medium contains computer program codes for carrying out one of the above methods. The term “computer-readable medium,” however, is not understood to mean exclusively hard disks and/or servers and/or memory sticks and/or flash memories and/or DVDs and/or Bluerays and/or CDs. In addition, the term “computer-readable medium” can also mean a data flow, for example, such as produced when a computer program and/or a computer program product is downloaded from the Internet.

### BRIEF DESCRIPTION OF THE DRAWINGS

Below, the invention is explained briefly with reference to drawings, which show:

FIG. 1: A schematic representation of a method according to the invention according to a preferred embodiment,

FIG. 2: A schematic representation of a system according to the invention,

FIG. 3: A schematic representation of a vehicle according to the invention.

### DESCRIPTION OF PREFERRED EXAMPLE EMBODIMENTS

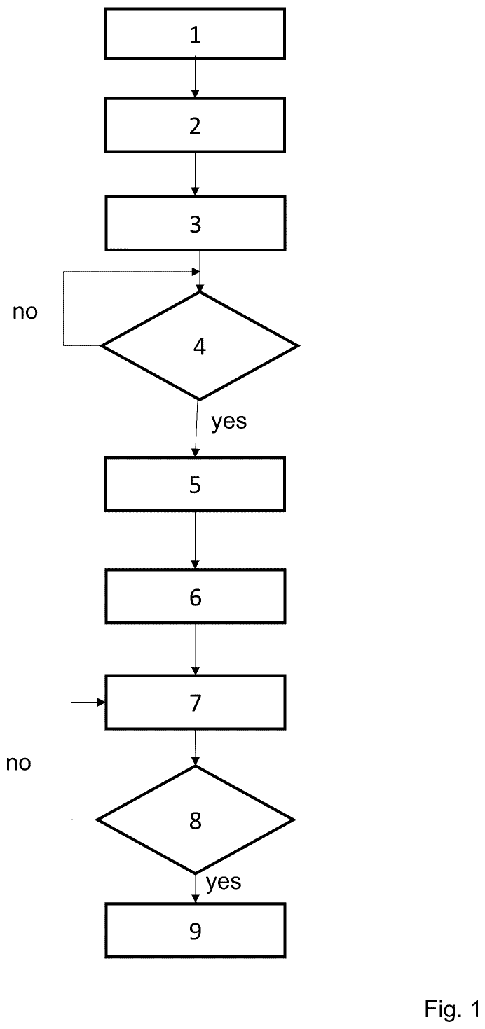

FIG. 1 shows a schematic representation of a method according to the invention, in a preferred embodiment. Specifically, Fig. I shows a method for ensuring a desired shifting state in a shiftable electric drivetrain of a vehicle. This method begins with an initial switching-on step 1. The initial switching-on step 1 can consist, for example, of a first turning of an ignition key of the vehicle by a driver, or the pressing of a switching-on button. This initial switching-on step 1 is followed by the switching-on shifting step 2 during which a shift is automatically made into the desired shifting state. The desired shifting state can be, for example, a mechanically neutral condition. Thus, it is ensured that as soon as the initial switching-on step 1 has been carried out, which for example can bring about an activation of terminal 30, then the desired shifting state is reached. The switching-on shifting step 2 is followed by the complete switching-on step 3, during which the vehicle is typically switched on, for example by activating terminal 15. The complete switching-on step 3 is followed by the shift-enabling test step 4, in which it is tested whether a shift-lever has been moved from a mechanically neutral position, for example from position “N” to a forward-driving position, e.g., to position “D”, or to a reverse-driving position, e.g., to position “R.” So long as that is not the case the vehicle is kept in the desired shifting state, for example the mechanically neutral shifting state. Only if that is the case, then a shift has taken place from the mechanically neutral condition to a forward-driving or a reverse-driving position, where the shift is a shift-enabling step 5 carried out which changes the vehicle to a driving condition in which the gears can be changed at will. In the example embodiment shown in FIG. 1, this state then enables an initial switching-off step 6 to be carried out. During the initial switching-off step 6, for example, a switching-off process of the vehicle can be carried out by turning the ignition key to a switching-off position. After the initial switching-off step 6 has been carried out a switching-off shifting step 7 is carried out, during which a shift takes place to the desired shifting state, for example to the mechanically neutral condition, and this indeed takes place automatically. The switching-off shifting step 7 is then followed by the switching-off test step 8, which tests whether the mechanically neutral position, or rather the desired shifting state, has in fact been reached. So long as this is not the case, then the switching-off shifting step 7 is triggered repeatedly. Only when the desired shifting stage has been reached, in particular the mechanically neutral condition, is the switching-off test step 8 enabled, and the vehicle is completely switched off in the system switching-off step 9. This can happen, for example, by deactivating the terminal 30. In this example embodiment, the terminal 15 is typically deactivated during the initial switching-off step 6.

In other embodiments, it is also possible for the switching-off test step 8 to be carried out before the switching-off shifting step 7, so that the switching-off shifting step 7 is then only carried out if the switching-off test step 8 has shown that the actual shifting state does not yet correspond to the desired shifting state,

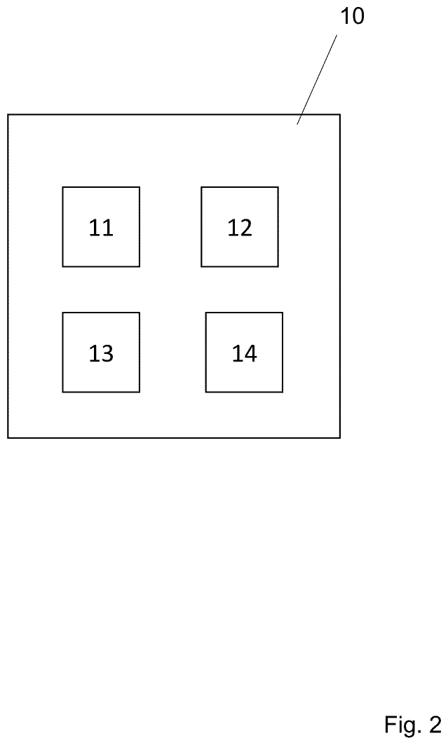

FIG. 2 shows a schematic representation of a system 10 according to the invention. The system 10 comprises a selection component 11, a switching-off component 12, a switching-on component 13, and a shift-enabling component 14. These components 11, 12, 13 and 14 enable the system 10 to carry out a method according to the invention, at least in part.

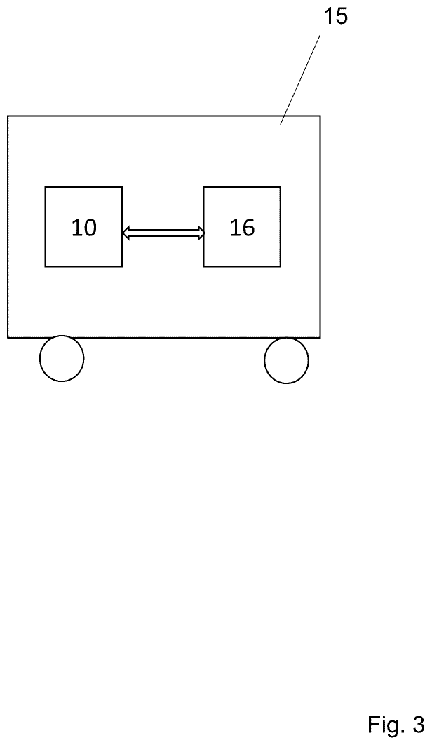

FIG. 3 shows a schematic representation of a vehicle 15 according to the invention. The vehicle 15 according to the invention comprises a shiftable electric drivetrain 16 and a system 10 according to the invention. The system 10 is coupled to the shiftable electric drivetrain 16 in such manner that a method according to the invention can be carried out In FIG. 3 that coupling is represented by a double-arrow between the system 10 and the shiftable electric drivetrain 16.

The invention is not limited to the example embodiments. Its protective scope is defined by the claims.

### Indexes

1 Initial switching-on step
2 Switching-on shifting step
3 Complete switching-on step
4 Shift-enabling test step
5 Shift-enabling step
6 Initial switching-off step
7 Switching-off shifting step
8 Switching-off test step
9 System switching-off step
10 System
11 Selection component
12 Switching-off component
13 Switching-on component
14 Shift-enabling component
15 Vehicle
16 Shiftable electric drivetrain

1. A method for ensuring a desired shifting state in a shiftable electric drivetrain (16) of a vehicle (15), the method comprising:
ascertaining that the desired shifting state corresponds to an actual shifting state.

2. The method according to claim 1, wherein the desired shifting state is a mechanically neutral condition or a condition with a gear engaged.

3. The method according to claim 2, comprising:
offering a user the possibility of selecting between the mechanically neutral condition and the condition with a gear engaged.

4. The method according to claim 1, comprising switching off the vehicle (15), wherein the ascertaining step comprises:
a switching-off test step (8), comprising determining whether the desired shifting state corresponds to the actual shifting state;
a switching-off shifting step (7), comprising shifting the electric drivetrain (16) into the desired shifting state;
determining that the desired shifting state corresponds to the actual shifting state; and
a system switching-off step (9), comprising switching off the vehicle (15) completely in response to determining that the desired shifting state corresponds to the actual shifting state.

5. The method according to claim 4, comprising:
switching on the vehicle,
wherein the ascertaining process further comprises:
a switching-on test step, comprising determining whether the desired shifting state corresponds to the actual shifting state;
the switching-on test step, further comprising determining that the desired shifting state does not correspond to the actual shifting state;
a switching-on shifting step (2), comprising shifting the electric drivetrain (16) into the desired shifting state;
determining that the desired shifting state corresponds to the actual shifting state; and
a complete switching-on step (3), comprising switching the vehicle fully on in response to determining that the desired shifting state corresponds to the actual shifting state.

6. The method according to claim 5, comprising a shift-enabling process carried out after the complete switching-on step (3) has been carried out, wherein the shift-enabling process comprises the following steps:
a shift-enabling test step (4), comprising testing whether a shift-lever actuation from a neutral position to a forward-driving or a reverse-driving position has taken place; and
a shift-enabling step (5), comprising fully enabling a shift of the electric drivetrain (16) in response to determining that the shift lever actuation from a neutral position to a forward-driving or a reverse-driving position has taken place.

7. A system (10) comprising means for carrying out, at least in part, the method according to claim 6.

8. A vehicle having a system configured for carrying out the method according to claim 1.

9. (canceled)

10. A computer-readable medium, comprising executable computer program codes for carrying out the method according to claim 1.

11. The method according to claim 4, wherein the ascertaining step further comprises determining that the desired shifting state does not correspond to the actual shifting state.
